(19) United States
(12) Patent Application Publication
(10) Pub. No.: US 2016/0343070 A1
(43) Pub. Date: Nov. 24, 2016

(54) Method for Automatically Calculating a Monthly Housing Expense Payment

(71) Applicant: MARTIN ALEJANDRO BAGLIONI, Coral Springs, FL (US)

(72) Inventor: MARTIN ALEJANDRO BAGLIONI, Coral Springs, FL (US)

(21) Appl. No.: 14/717,745

(22) Filed: May 20, 2015

(51) Int. Cl. G06Q 40/00; G06Q 50/16

(52) U.S. Cl. CPC G06Q 40/00; G06Q 50/16

(57) ABSTRACT

A method for automatically calculating a monthly housing expense payment includes reading data and calculating a really close approximation to the monthly housing expense payment for a property or plurality of properties, by incorporating the principal and interest payment for different loan types or the loan type a specific buyer would have, incorporating the actual property tax, an estimation of the property insurance percentage, the mortgage insurance percentage premium if applicable, and community association fees, if applicable.

The method generates a more realistic projection of a buyer's capacity to pay all the fees the bank will require to be paid for at least one property by integrating accurate data, actual costs and estimations of those that cannot be known ahead of buying real estate of the different elements that compose the monthly housing expense payment but are not normally calculated or displayed when viewing or considering buying a property.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to a method for reading data to calculate the monthly housing expense payment for a property by incorporating actual property tax, property insurance percentage, mortgage insurance percentage and association fees.

The inventor is involved in the real estate brokerage business. The inventor was aware that prequalification for a real estate loan was the first step to determining whether the lender can tender a loan to the buyer, and the maximum amount of the loan that can be tendered. The inventor benefited when a buyer was prequalified for the loan because the inventor could then find the buyer a property based on the prequalification amount.

The inventor recognized that a lender, such as a bank, had to preview whether the buyer had a reasonable chance to obtain a loan before reaching the more involved preapproval step of the loan process. This prequalification was often based on the income, possible housing monthly housing expense payment, assets, debt and strength of the employment. In general, the prequalification allowed the buyer to immediately know what purchase price is possible to buy.

The inventor recognized a problem in that many buyers were prequalified, preapproved and even approved for a real estate loan up to a certain purchase price, but later were denied the loan due to higher than expected monthly housing expense payment. For example, often two neighboring properties with the same loan amount and purchase price will have different housing expense payments. This may be due to the fact that each property may have different property taxes, property insurance, and association fees, if any. This leads to the buyer later having problems in obtaining the loan due to higher than initially thought monthly housing expense payment and generally because the housing expenses used to calculate the preapproval are guesstimated since the lender is unaware of which, among the thousands of houses available for sale, the buyer will elect to pursue. The inventor realized that the preapproval also provided a false sense of security to the seller of the property, and the prequalification amount was often discriminatory to someone with less than perfect credit or who is putting little or nothing down.

The inventor came to the conclusion that the buyer would benefit from an automatic reading of data that would automatically calculate and display the expected housing expense monthly payment, in turn this would help the buyer better evaluate a potential property and know the approximate housing payment of a particular or plurality of properties even before seeing the property. The present invention also helps a buyer avoid seeing and pursuing properties that are higher than the maximum monthly housing expense payment that the buyer would qualify for, and find properties that otherwise would be beyond his or her reach because they are priced substantially above the prequalification purchase price amount, yet are at or below the maximum qualifying housing expense monthly payment. This prequalification helps the seller avoid pulling the property off the market only later to find out the buyer cannot qualify for the new loan needed to complete the purchase because of housing expense payments.

Thus, the inventor saw a great need for more accurate prequalification means. Through additional research, the inventor learned that most mortgage companies prequalified loans based on a housing expense ratio and a debt to income ratio, and used information such as buyer's income, debt, assets, reserves, and strength of employment against loan principal payment costs for the property, interest payments for the property, taxes for the property, property insurance premium, mortgage insurance premium and association fees.

Through research and experience, the inventor realized that most buyers only considered the prequalification amount for a purchase price, and later faced additional, unexpected monthly housing expense payments that were not initially calculated into the price prequalification calculations. This resulted in loan denials or unaffordable housing that had purchase prices at or below the prequalification amount.

The inventor recognized that association fees were one such fee that often overlooked. This was because association fees only exist if there is an association present in the development. The inventor integrated this fee into the monthly housing expense payment calculation display. The results showed a higher monthly obligation requirement for the buyer. However, it was more indicative of what the buyer would face if the dwelling were purchased, for it is a fee that the banks consider into the housing expense ratio.

The inventor looked for other expenses that could produce a more accurate housing expense calculation. Through trial and error the inventor recognized that the property insurance costs for the property depended on the location, the deductibles, the coverage, inspection reports and overall resilience to obtain a better premium and varied depending on the knowledge or advice received by the buyer on how to shop for property insurance percentage. However, the inventor discovered that there is a common occurrence percentage in relationship to the price in each locality, and was able to establish the minimum premium for a property insurance percentage policy assuming a higher deductible, average inspection reports and lesser coverage and automatically list this estimated percentage for each property. Most payment calculators totally omit the property insurance percentage or leave the number in blank subject to the knowledge or lack thereof of the buyer as to how much the monthly property insurance premium would be, rendering the calculation incomplete and non-representative of the real housing payment. This property insurance percentage rate was also integrated into the monthly housing expense payment calculation to achieve a more accurate calculation, for it is a fee that the banks consider into the housing expense ratio.

The inventor looked for other monthly housing expense payments that could produce a more accurate housing expense calculation. The inventor recognized that the mortgage insurance percentage is often overlooked but always present when the buyer puts less than 20% down payment. The monthly rate changes according to the loan type and amount of money down. This mortgage insurance percentage rate was also integrated into the monthly housing expense payment calculation to achieve a more accurate housing expense calculation, for it is a fee that the banks consider into the housing expense ratio.

The inventor looked for every other monthly housing expense payment components that banks consider when approving loans. The inventor recognized that property tax are a part of the housing expense calculation however, totally absent or established as a percentage in payment calculators, thus giving inaccurate housing expense calculations. The actual property tax related to every specific property was also integrated into the monthly housing expense payment calculation to achieve a more accurate housing expense calculation, for it is a fee that the banks consider into the housing expense ratio.

The inventor next wondered if the more accurate monthly housing expense payment information could be used to help the buyer obtain a better deal. The inventor added a function that enables negotiation of the final monthly housing expense payment and property insurance percentage rate. Thus, the maximum payment capacity of the buyer could be used as leverage against the more accurate housing expense calculation to argue for a better property insurance percentage rate, a better interest rate, or even a better purchase price.

For the foregoing reasons, there is a need for a method for automatically reading data and calculating the monthly housing expense payment that incorporates the principal and interest payment the actual property tax, property insurance percentage, mortgage insurance percentage and actual association fees.

Amortization, prequalification and loan calculation methods in the mortgage industry have been utilized in the past; yet none with the present delivery expediting characteristics of the present invention. See U.S. Pat. No. 8,768,827; 8,909,551; 20060178983, and 20050086157.

For the foregoing reasons, there is a method that produces a more accurate projection of a buyer's capacity to qualify for a real estate loan for a property by adding in the monthly payment of principal and interest the actual property tax, property insurance percentage, mortgage insurance percentage and actual association fees, also known as, the housing expense ratio calculations used to qualify a borrower, and then using the more accurate housing expense payment to negotiate a better deal.

### SUMMARY

The present invention describes a method for automatically reading data to calculate and display the monthly housing expense payment used by banks to qualify a borrower and that a buyer would have when purchasing real estate by automatically reading and incorporating into the monthly payment the actual property tax, automatically adding a user defined property insurance percentage calculation or allow a user defined dollar amount, automatically adding mortgage insurance percentage when appropriate, and automatically reading and incorporating the actual association fees into the monthly housing expense payment calculations.

The method for software automatic reading of data to calculate the housing expense monthly payment, hereafter, “method”, produces a more accurate projection of a buyer's capacity to qualify for a real estate loan for at least one property by including in the monthly payment the actual property tax, property insurance percentage calculation or user defined dollar amount, mortgage insurance percentage and actual association fees into the housing expense calculations to the typical principal and interest expenses when performing the automatic calculations and displaying the results of such calculations.

The integration of the actual property tax, property insurance percentage calculation or user defined dollar amount, mortgage insurance percentage and actual association fees into the monthly payment, also known as the housing expense calculations, enables the buyer to identify a property based on a projected housing expense payment, rather than just the price of the property. This more precise data helps the buyer understand the true maximum housing payment capacity of the buyer, it allows the buyer find a substantially more expensive property for the same housing payment that a much less expensive property, it avoids unnecessary viewings of properties that the buyer could not qualify to buy, it avoids evident loan denials based on the housing payment being too high, it gives a real estate seller more confidence in buyer's ability to obtain a loan, and also helps the buyer in negotiation of property insurance percentage premium, interest rate and better price for the at least one property when the information is used as leverage.

The additional expenses to the usual automatic calculation and display of 80% conventional loan financing principal and interest monthly payment may include, without limitation: 1) actual association fee for a property; and 2) property insurance percentage estimated cost that is specific to the area of the property; 3) mortgage insurance percentage relevant to the loan type the buyer is getting; 4) actual property tax that is specific to the property being evaluated; and 5) a user defined interest rate. Also, principal and interest for FHA and VA loans are calculated, and a property identifier, such as MLS# is provided, though not included in the calculation. These variables are used to obtain the monthly housing expense payment. They allow the buyer to use the information to make decisions and identify properties of interest, unlike the sometimes useless automatic display of 80% financing payment of principal and interest, for flawless credit and perfect loan scenario common in the industry.

The listing price, the actual property tax, and the actual association fee are directly extracted form a real estate database, such as the Multiple Listing Service (MLS). The property insurance percentage and the mortgage insurance percentage are entered during a set up. The interest rate is manually entered one time according to each buyer specifications or credit worthiness and based on the interest rate at the time.

In a second phase, the monthly housing expense payment is integrated into the system, such that it displays on an MLS, a real estate database or a website.

Thus, in essence, the method includes reading data and calculating a really close approximation to the monthly housing expense payment for a property or plurality of properties, by incorporating the principal and interest payment for different loan types or the loan type a specific buyer would have, incorporating the actual property tax, an estimation of the property insurance percentage, the mortgage insurance percentage premium if applicable, and community association fees, if applicable.

The method generates a more realistic projection of a buyer's capacity to pay all the fees the bank will require to be paid for at least one property by integrating accurate data, actual costs, and estimations of those that cannot be known ahead of buying real estate of the different elements that compose the monthly housing expense payment but are not normally calculated when viewing or considering buying a property. Consequently, the buyer can identify an appropriate property based on a projected monthly housing expense payment, rather than just the price of the property. This more precise property prequalification data helps a real estate agent and seller better understand the maximum housing expense capacity of the buyer, easily identify the better deals for a buyer, and also helps in negotiation of actual insurance expenses and the overall purchase price amount for the property.

The calculation may be applied to different types of loans, including, without limitation, federal housing administration loans (FHA), veteran administration loans (VA) and conventional loans with different percentages of down payment, such as, without limitation to five percent (5%), ten percent (10%), fifteen percent (15%), twenty percent (20%) and thirty percent (30%). The standard expenses used for the automatic reading of data in most payment calculators may include, principal and interest payment for a property, financing with a conventional loan putting twenty percent down payment. Some other manual (not automatic) calculators will have property tax expressed as a percentage (not actual property tax), an empty dollar amount left to fill for homeowners insurance, a seemingly inaccurate percentage for mortgage insurance percentage and an empty dollar amount left to fill for association fees. There is no automatic reading of data for those expenses and the user must manually enter the information.

By including the automatic reading and display of data for real estate properties and including the additional expenses described above, the buyer can identify appropriate real estate property to purchase based on monthly housing expense payment, rather than just the purchase price of the property. Also, the method enables a lender to produce a more accurate prequalification letter for the buyer, and a seller can have a better understanding of whether the buyer is prequalified to purchase the seller's house before prematurely pulling the property off the market.

In one embodiment, the real estate database is integrated within the system. In this manner, the monthly housing expense payment displays on an MLS or a real estate database or a spreadsheet.

In another aspect, the system displays the monthly housing expense payment.

In another aspect, the system displays the monthly housing expense payment as a dollar amount.

In another aspect, the system displays the monthly housing expense on a spreadsheet.

In another aspect, the listing price and the interest rate include at least one member form the group consisting of: an FHA loan, a VA loan, and a conventional loan other than 20 percent down.

In another aspect, the property is a residential home.

In another aspect, the association fee is a home owner's association fee.

In another aspect, the user is a borrower, a real estate buyer, a real estate agent, a loan originator, or any person or entity interested in calculating or knowing a monthly housing expense payment.

In another aspect, the real estate database is provided by a multiple listing service.

In another aspect, the method is operable through the Internet.

The first additional expense incorporated by the method is the automatic reading of the association fee for the property. The association fee may include, without limitation, a home owners association or condominium association fees. A home owners association (HOA) is a corporation formed by a real estate developer for the purpose of marketing, managing, and selling of homes and lots in a residential subdivision. The HOA grants the developer privileged voting rights in governing the association, while allowing the developer to exit financial and legal responsibility of the organization. Membership in the HOA by a real estate buyer is typically a condition of purchase; whereby a buyer isn't given an option to reject it.

The second additional actual expense is the real estate property tax, specific to the property of interest. Property tax is a tax assessed on real estate by the local government and is usually based on the value of the property or the purchase price, a tax rate, exemptions or discounts to taxation, and it includes the value of the land. The actual tax may include, without limitation, the ad valorem taxes, non ad valorem assessments or combined taxes and assessments. Typically, calculators known in the art utilize a generic property tax percentage rate that often isn't realistic for the county the property is in, the neighborhood, and most importantly, the actual property of interest. For example, a calculator could calculate or display 1.2% for all properties. When a new real estate transaction occurs, the new owner will generally inherit the previous owner's property taxes for the year the property is bought in, and later on assessed as described above with deductions based on their very own exceptions to taxation, such as and without limitation, homestead exemption, disability exemption, widowers exemption, deployed military exemption, combat wounded disabled exemption, veteran's service connected total and permanent disability exemption, blind exemption, granny exemption, surviving spouse of military veteran or first responder exemption, and other exemptions that different localities may have. While the calculator simply uses a 1.2% rate for all properties, this is not an accurate reflection of the actual property tax, thus highly impacting the housing expense monthly payment and not reflecting whether or not the buyer could qualify to purchase a specific property.

The third additional expense is the automatic estimation of the property insurance percentage cost, specific to the property. Property insurance percentage costs for the property depended, without limitation, to the location, the deductibles, the coverage, inspection reports and overall resilience to obtain a better premium and varied depending on the knowledge or advice received by the buyer on how to shop for property insurance premium. However, the inventor discovered that there is a common occurrence percentage in relationship to the price in each locality, and was able to establish the minimum premium for a property insurance percentage policy assuming a higher deductible, average inspection reports and lesser coverage and automatically list this estimated percentage for each property. Automatic payment calculators totally omit the cost of insurance, and payment calculators that the user enters the data manually either totally omit the property insurance percentage cost or leave the number in blank subject to the knowledge or lack thereof of the buyer as to how much the monthly property insurance percentage premium would be, rendering the calculation incomplete and non-representative of the housing payment. This property insurance percentage rate estimation was also integrated into the automatic monthly housing expense payment calculation display to achieve a more accurate calculation.

The fourth additional monthly housing expense payment is the automatic addition for certain type of loans of the mortgage insurance percentage. As part of the loan qualifications set out most lenders, a borrower is required to pay mortgage insurance percentage when the borrower does not provide at least twenty percent (20%) of a home's purchase price as a down payment, with the exemption of lender paid mortgage insurance percentage. It normally is paid by the borrower, and it protects the lender against loss if a borrower defaults on the loan. The mortgage insurance percentage premium varies according to the loan type, and the percentage of amount of money down. for example, VA loans do not have monthly mortgage insurance percentage, mandatory FHA monthly mortgage insurance percentage premium is generally about zero point eight five percent (0.85%) of the loan amount divided by twelve (rate subject to change), and for conventional loans putting five percent down (5%) generally is zero point five percent (0.5%) of the loan amount divided by twelve (rate subject to change). Loans that have lender paid mortgage insurance percentage typically increase the prevailing interest rate to offset the cost of the mortgage insurance percentage thus making the monthly housing expense payment cost similar to a property with a payment with prevailing interest rate and mortgage insurance percentage. Automatic payment calculators totally omit the cost of mortgage insurance, and payment calculators that the user enters the data manually either totally omit the mortgage insurance cost, do not give the option for the different loan types, do not disclose what is the percentage being used, or leave the number in blank subject to the knowledge or lack thereof of the buyer as to how much the monthly property insurance percentage premium would be, rendering the calculation incomplete and non-representative of the real housing payment. This mortgage insurance percentage rate was also integrated into the automatic monthly housing expense payment calculation display for each loan type to achieve a more accurate calculation.

The fifth expense is the automatic reading of data to accurately represent the principal and interest payment for the different loan types. Principal and interest payments are directly related to the loan amount, and different loan types have substantially different loan amounts. For example, a borrower for a conventional loan financing eighty percent of the purchase will have a lower loan amount than a VA borrower financing one hundred percent of the purchase, and then an FHA borrower financing ninety six and a half percent of the purchase. Existing automatic principal and interest payment calculators display calculations for borrowers financing eighty percent of the purchase and do not calculate payments for VA or FHA loans. For manual calculators, users are required to enter a loan amount by entering a percentage of money down and depends on user knowledge or lack thereof to guess what is required to put down to obtain a loan. The calculator depends on the knowledge or lack thereof of the borrower, and if the user does not know the minimum requirements, it renders the calculation incomplete, inaccurate and non-representative of the real housing payment. The automatic calculation of principal and interest payments for the different loan types, including but not limited to FHA, VA, and conventional loans were included in the display by either the user selecting the loan type during a session, or automatically displaying payments for the different loan types to be useful and representative of each borrower type of monthly housing expense payment.

The method is effective because it would help the buyer better evaluate a potential property and automatically know if the buyer can afford it, want to pay it, or qualify to pay the monthly housing payment for one or more properties even before seeing the property; it will reduce unnecessary viewing of houses that the buyer cannot afford or qualify to buy, avoid pursuing unaffordable properties or properties that the buyer would not qualify for the loan, the buyer can find properties that are substantially more expensive in purchase price for the same monthly housing payment than other properties with a substantially lower prices, and it will help the seller avoid pulling the property off the market only to find out the buyer cannot qualify for the new loan needed to complete the purchase because of housing expense payments.

The addition of the additional expenses to the above standard principal and interest expenses produces a narrower, more accurate expectation of the housing expense payments for the property. Further, in addition to the additional expenses outlined above, the method may also provide a deeper investigation of the financial ability of the buyer. In this manner, the most accurate projection for the buyer's capacity to purchase a property is made available, as it is displayed for consumption.

In some embodiments, the method enables negotiating of the actual insurance cost expense to enable convergence with the maximum capacity for the monthly housing expense payment. The buyer and lender can try to leverage the maximum monthly housing expense payment for the buyer to negotiate a lower actual insurance cost. Similarly, the overall purchase price can then be negotiated to enable convergence with the maximum capacity for the monthly housing expense payment.

In essence, the method is configured to simultaneously and automatically produce the monthly housing expense payment for each property by adding the additional expenses described above. Then using the housing expense payment capacity of the buyer, the lender and buyer can realize if there exists a payment excess or shortfall to meet the monthly housing expense payment qualification. Using this final piece of financial data, the actual property insurance percentage cost and even the overall purchase price of the property may be negotiated to more favorable terms.

The method may include an initial Step of using a real estate database, the real estate database comprising at least one property available for purchase. A next step comprises of the automatic reading of data, calculation of the housing expense payment and display of the housing expense payment of at least one property and for the different loan types.

An alternative method includes selecting at least one property from the real estate database. A step comprises extracting property identification, such as address or MLS number, the asking price of a property, the property tax, and the association fees, if any. A further step comprises of importing or copying and pasting the property identification, such as address or MLS number, the asking price of a property, the property tax, and the association fees, if any into the computer software. A step comprises of the automatic reading of data, calculation of the housing expense payment and display of the housing expense payment of at least one property and for the pertinent loan type.

A further step of the method may include negotiating the actual purchase price of the property, the negotiation configured to enable convergence with the maximum capacity for the monthly housing expense payment. An additional step of the method comprises negotiating the property insurance premium, the premium negotiation configured to enable convergence with the maximum capacity for the monthly housing expense payment. A final Step comprises analyzing the results of the calculation for at least one property in contrast with the buyer's financial needs.

One objective of the present invention is to provide an easy to use monthly housing expense payment calculator that includes all the different elements that a bank will take into account when qualifying a borrower for a loan, such as the addition of principal, interest, property tax, property insurance percentage, mortgage insurance percentage if applicable, and community association fees, if present.

Another objective of the present invention is to locate at least one property for purchase based on the monthly housing expense payment of a property, rather than the price of the property.

Another objective of the present invention is to discover how much the monthly housing expense payment is for a plurality of properties on a real estate database.

Yet another objective is to quickly gauge if a property is affordable based on the housing expense payment.

Yet another objective is to quickly determine if a property is suitable for the user based on whether or not the user could qualify for the loan.

Yet another objective is to diminish the amount of buyer loan denials based on housing expense payments being higher than the qualified amount by avoiding the buyer's pursuit of properties that have a higher housing expense payment than the one the buyer qualifies for.

Yet another objective is to import property data from a real estate database, such as but without limitation, the multiple listing service (MLS).

Another objective of the present invention is to provide an easy to use mortgage calculator that works in conjunction with the real estate database, such as but without limitation, the MLS to display properties and their respective monthly housing expense payments.

Yet another objective of the present invention is to locate more expensive properties with the same monthly housing expense payment than less expensive properties.

Yet another objective of the present invention is to utilize the monthly housing expense payment to negotiate the actual property insurance cost in relationship to the overall housing expense monthly payment capacity of the buyer.

Yet another objective is to compare properties based on monthly housing expense payments.

### DRAWINGS

These and other features, aspects, and advantages of the present invention will become better understood with regard to the following description, appended claims, and drawings where:

FIG. 1 is an exemplary table from a real estate database showing the additional expenses, standard expenses, and payment excess or shortfall for multiple properties;

FIG. 2 is a flowchart diagram of an exemplary method for automatically reading and calculating a monthly housing expense that a buyer will be able to pay if the buyer elects to purchase a certain property;

FIG. 3 is a block diagram depicting an exemplary client/server system which may be used by an exemplary web-enabled/networked embodiment of the present invention; and

FIG. 4 is exemplary data from a real estate database for a specific property, showing the present invention with automatic reading of data along with the calculation of the different housing expense payments for different loan types.

### DESCRIPTION

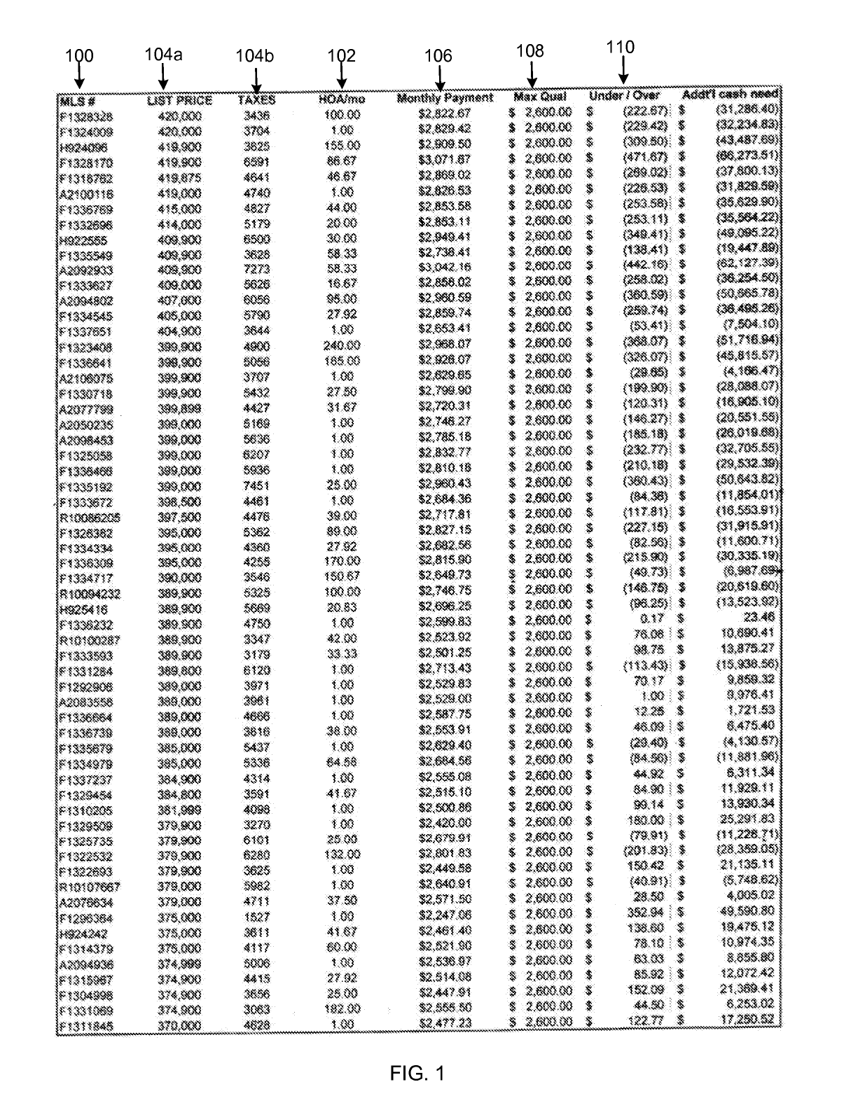

The present invention, referenced in FIGS. 1-4, is directed to a method 200 for automatically reading and calculating a monthly housing expense that a buyer will be able to pay if the buyer elects to purchase a certain property.

The method 200 automatically reads data to calculate and displays a monthly housing expense payment that banks use to qualify a borrower. The method 200 for automatically reading and calculating a monthly housing expense that a buyer will be able to pay if the buyer elects to purchase a certain property hereafter, “method 200”, generates a more accurate projection of a buyer's repayment capacity 108 to repay a real estate loan for at least one property 100 by projecting an estimate for a housing monthly housing expense payment payment. The housing monthly housing expense payment is based on the extraction and estimation of variables known in the art to determine mortgage costs and expenses.

Thus, while performing the monthly housing expense payment calculations, the 1) principal and interest 104a for the property 100; 2) actual association fee 102 for a property 100; and 3) property insurance percentage estimated cost that is specific to the area of the property; 4) mortgage insurance percentage relevant to the loan type the buyer is getting; 5) actual property tax 104b that is specific to the property being evaluated; and 6) an interest rate. Also, a property identifier, such as MLS# is provided, though not included in the calculation. These variables are used to calculate a monthly housing expense payment.

The listing price 104a, the actual property tax 104b, and the actual association fee 102 are directly extracted form a real estate database, such as the Multiple Listing Service (MLS). The property insurance percentage and the mortgage insurance percentage are estimate during a set up. The interest rate is provided based on the interest rate at the time, and buyer's own loan scenario merits.

In one embodiment, the real estate database is integrated within the system. In this manner, the monthly housing expense payment displays on an MLS, a real estate database, a website or a spreadsheet.

In another aspect, the system displays the monthly housing expense payment.

In another aspect, the system displays the monthly housing expense payment as a dollar amount.

In another aspect, the system displays the monthly housing expense on a spreadsheet.

In another aspect, the listing price and the interest rate include at least one member form the group consisting of: an FHA loan, a VA loan, and a conventional loan.

In another aspect, the property is a residential dwelling.

In another aspect, the association fee is a home owner's association fee.

In another aspect, the user is a borrower, a real estate buyer, a real estate agent, a loan originator, or any person or entity interested in calculating or knowing a monthly housing expense payment.

In another aspect, the real estate database is provided by a multiple listing service.

In another aspect, the method is operable through the Internet.

Furthermore, the loan may be applied to different types of loans for the property 100, including, without limitation, federal housing administration loans (FHA), veteran administration loans (VA) and conventional loans with different percentages of down payment, such as, without limitation to five percent (5%), ten percent (10%), fifteen percent (15%), twenty percent (20%) and thirty percent (30%).

The standard expenses used for the automatic reading of data in most payment calculators may include, principal and interest payment for a property, financing with a conventional loan putting twenty percent down payment. Some other manual (not automatic) calculators will have property tax expressed as a percentage (not actual property tax), an empty dollar amount left to fill for homeowners insurance, a seemingly inaccurate percentage for mortgage insurance percentage and an empty dollar amount left to fill for association fees. There is no automatic reading of data for those expenses and the user must manually enter the information.

By including the automatic reading and display of data for real estate properties and including the additional expenses described above, the buyer can identify appropriate real estate property to purchase based on monthly housing expense payment, rather than just the purchase price of the property. Also, the method enables a lender to produce a more accurate prequalification letter for the buyer, and a seller can have a better understanding of whether the buyer is prequalified to purchase the seller's house before prematurely pulling the property off the market.

These costs are added to the standard principal and interest calculation known in the art to produces a more accurate projection of a buyer's capacity to qualify for a real estate loan for at least one property 100 by including actual property tax, property insurance percentage calculation or user defined dollar amount, mortgage insurance percentage and actual association fees into the housing expense calculations to the typical principal and interest expenses when performing the automatic calculations.

Consequently, the integration of these additional costs into the monthly housing expense payment calculations enables the buyer to locate an appropriate property 100 based on a projected monthly payment 106, rather than just the price of the property 100. This more precise monthly housing expense payment data helps a lender and seller better understand the maximum housing expense payment capacity 108 of the buyer, and also helps in negotiation of an actual insurance cost and the overall amount of the monthly housing expense payment 106 for the property 100.

The method 200 allows the buyer find a substantially more expensive property 100 for the same housing payment that a much less expensive property, it avoids unnecessary viewings of properties that the buyer could not qualify to buy, it avoids evident loan denials based on the housing payment being too high, it gives a real estate seller more confidence in buyer's ability to obtain a loan, and also helps the buyer in negotiation of property insurance percentage premium, interest rate and better price for the at least one property when the information is used as leverage.

In some embodiments, the method 200 may be operable on a website of the Internet, such as a website for a real estate organization. In this manner, the buyer, the lender, the seller, or a real estate agent may access and operate the method 200 to achieve real monthly housing expense payment goals. The method 200 utilizes at least one real estate database, such as those supplied by a multiple listing service (MLS). In one embodiment, the MLS provides a plurality of properties in a table or spreadsheet format. In one embodiment, the real estate database comprises a series of columns and rows that make up a table. The table may be imported as a txt. file for accessing the properties 100 contained therein.

As illustrated in FIG. 1, the method 200 is configured to simultaneously produce the monthly housing expense payment 106 for multiple properties 100 using the additional expenses described above. Then using the repayment capacity 108 of the buyer, the lender and buyer can realize if there exists a repayment excess or shortfall 110 to meet the maximum monthly housing expense payment 106. Using this final piece of financial data, the actual insurance cost and even the overall monthly housing expense payment 106 may be negotiated to more favorable terms.

As referenced in FIG. 1, the additional expenses are incorporated with the standard expenses to obtain a more accurate projection of the monthly housing expense payment 106 amount. The additional expenses to the usual principal and interest automatic calculation may include, without limitation: 1) actual association fee 102 for a property 100; and 2) property insurance percentage estimated cost that is specific to the area of the property; 3) actual property tax 104b that is specific to the property being evaluated; and 4) mortgage insurance percentage relevant to the loan type the buyer is getting. Though in other embodiments, the additional expense may also include, without limitation, unique regional taxes, penalties, water and drainage impact fees, late filing fees, background check fees, and conservation related fees. However, the additional expenses generally relate to perpetual monthly housing expense payments.

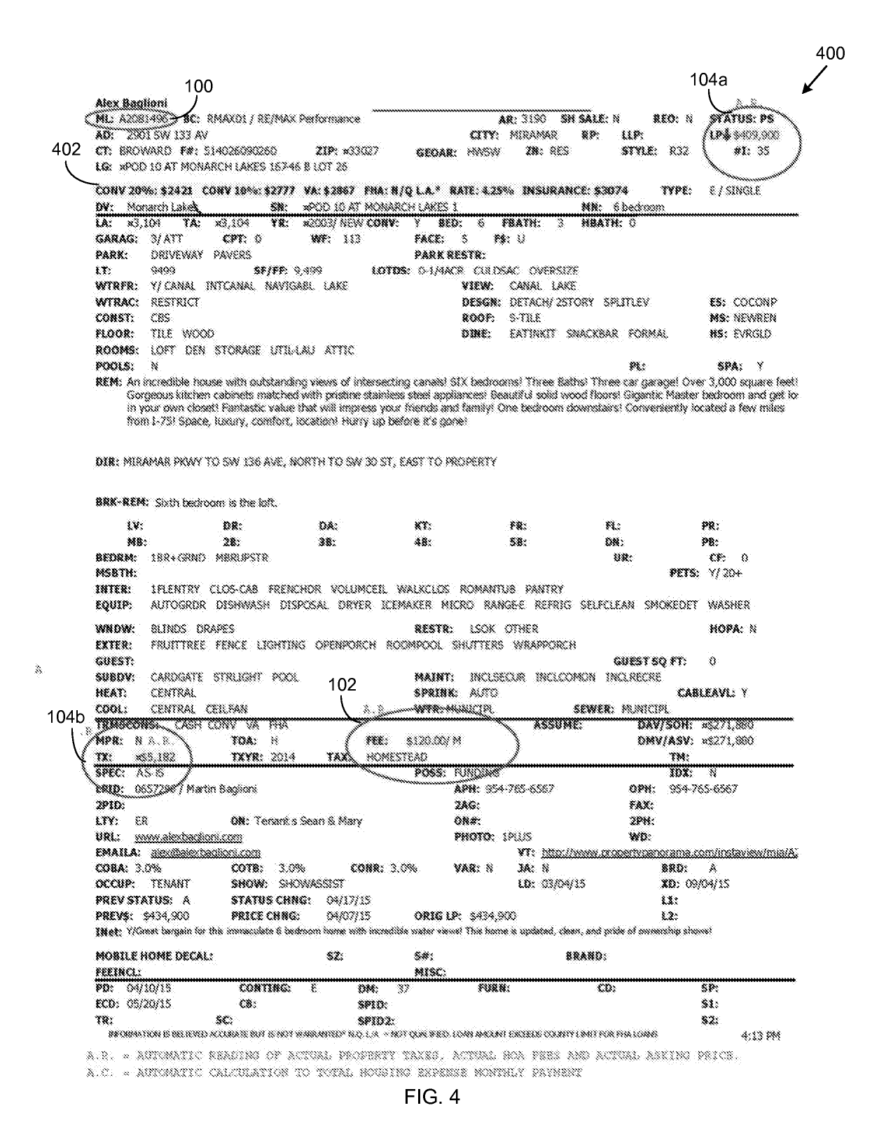

By including the additional expenses to the typical automatic calculation of 20% down principal and interest payment, and including the loan type relevant to the buyer, the buyer can identify appropriate real estate property 100 to purchase based on expected monthly housing expense payment 106, rather than the purchase price of the property 100. Also, the method 200 enables a lender to produce a more accurate loan model for the buyer, and a seller can have a better analysis of whether the loan will go through before prematurely pulling the property 100 off the market. FIG. 4 references data report 400 from a real estate database for a specific property 100, showing the automatic reading of data along with the automatic calculation of the housing expense payment. An expense row 402 on the report 400 indicates the monthly housing expense payments for 10% down payment, 20% down payment, the VA loan amount, the FHA, the rate, and the insurance cost.

As discussed above, one of the additional expenses that is incorporated into the method 200 is the association fee 102 for the property 100. The association fee 102 may include, without limitation, a home owner's association fee. Those skilled in the art will recognize that a home owners association (HOA) is a corporation formed by a real estate developer for the purpose of marketing, managing, and selling of homes and lots in a residential subdivision. The

HOA grants the developer privileged voting rights in governing the association, while allowing the developer to exit financial and legal responsibility of the organization. Membership in the HOA by the buyer is typically a condition of purchase; whereby the buyer isn't given an option to decline the association fee 102.

Another possible additional expense is the estimated insurance cost, specific to the area of the property 100. The actual insurance cost may include, without limitation, a mortgage insurance percentage premium (MIP) rate, and a private mortgage insurance percentage (PMI) rate. The actual insurance cost is obtained specific to the property 100 in a neighborhood. Typically, prequalification calculators known in the art utilize a generic insurance rate that isn't realistic for the area or neighborhood of the property of interest. For example, many neighborhoods have an insurance rate between 0.5%-1.5%, while the mortgage calculator simply uses a 0.5% rate for all properties.

Because the prequalification calculator of the prior art utilizes 0.5% as the standard rate while preforming prequalification calculations, the monthly housing expense payment is not accurate. Thus, the lower rate of the insurance undervalues the expected monthly housing expense payments 106 associated with the property 100, and thereby does not provide an accurate loan amounts and potential loan payments the for the buyer, lender, or seller.

The method 200 is effective because it adds these two additional expenses to at least one standard expense known in the art. The at least one standard expense may include, without limitation, buyer income, buyer debt, buyer assets, listing prices for the property 100, interest payments for the property 100, taxes for the property 100, and initial down payment for the property 100. Though, in many cases, a buyer income and debt are the only two expenses calculated into the prequalification calculations.

The addition of the two additional expenses to the above standard expenses produces a narrower, more accurate expectation of the loan payments for the property 100. Further, in addition to the additional expenses of association fees 102 and actual insurance cost, the method 200 may also provide a deeper investigation of the financial history of the buyer. In this manner, the most accurate projection for the buyer's capacity to repay the loan is made available, as it is displayed for consumption.

This more precise data helps the buyer understand the maximum housing payment capacity of the buyer, it allows the buyer find a substantially more expensive property 100 for the same housing payment that a much less expensive property 100, it avoids unnecessary viewings of properties that the buyer could not qualify to buy, it avoids evident loan denials based on the housing payment being too high, it gives a real estate seller more confidence in buyer's ability to obtain a loan, and also helps the buyer in negotiation of property insurance premium, interest rate and better price for the at least one property when the information is used as leverage.

In some embodiments, the method 200 enables negotiating of the actual insurance cost expense to enable convergence with the maximum capacity for the monthly housing expense payment 106. In this manner, the buyer and lender can attempt to leverage the monthly housing expense payment 106 for the buyer to negotiate a lower actual insurance cost, or vice versa. Similarly, the overall monthly housing expense payment 106 can be negotiated to enable convergence with the maximum capacity for the monthly housing expense payment 106.

Those skilled in the art will recognize that prequalification for a real estate loan is a first step to determining whether the lender can loan to the buyer, and the maximum amount of the loan. Thus, the method 200 enables a buyer to preview whether the buyer has a reasonable chance to obtain the property 100 before reaching the more involved preapproval step of the loan process. The method 200 also helps a buyer to find the desired property 100 based on monthly housing expense payments, which includes the aforementioned additional expenses. In addition, the method 200 allows a buyer to immediately know what property is possible to buy.

Furthermore, the monthly housing expense payment calculation method 200 also helps a seller avoid pulling the property 100 off the market only to find out the buyer cannot qualify for the new loan needed to complete the purchase due to the housing expense payment being higher than anticipated by the loan originator working for the bank. The seller is aware of the buyer's housing expense payment capacity, as stated in the prequalification letter, and is able to see how much the property housing expense payment is.

Regular prequalification letters stating a purchase price only provide a false sense of security to the seller, and often is discriminatory to someone with less than perfect credit or who is putting little or nothing down. Thus, by including the maximum monthly housing expense payment in the prequalification letter, and the seller observing the automatic calculation of the housing expense payment for the seller's house, the buyer, lender, and seller are more informed and protected.

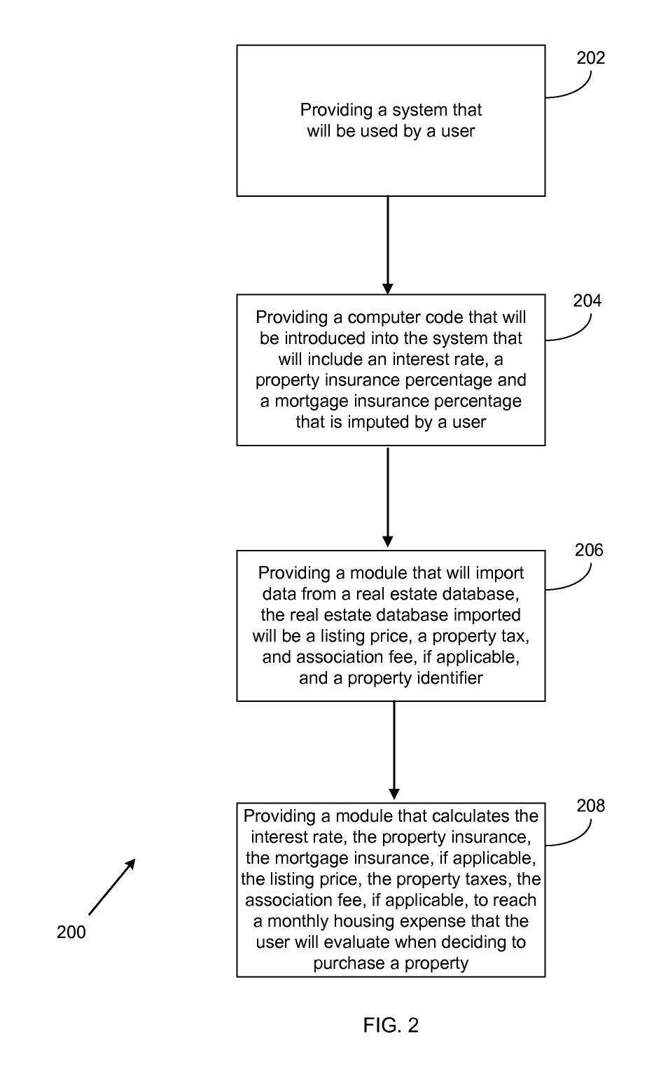

As shown in the flowchart of FIG. 2, the method 200 includes an initial Step 202 of providing a system that will be used by a user.

A next Step 204 includes providing a computer code that will be introduced into the system that will include an interest rate, a property insurance percentage and a mortgage insurance percentage that is imputed by a user.

The method 200 may then proceed to a Step 206 that comprises providing a module that will import data from a real estate database, the real estate database imported will be a listing price, a property tax, and association fee, if applicable, and a property identifier.

A final Step 208 includes providing a module that calculates the interest rate, the property insurance percentage, the mortgage insurance percentage, if applicable, the listing price, the property taxes, the association fee, if applicable, to reach a monthly housing expense that the user will evaluate when deciding to purchase a property.

The real estate database may include those known in the field of real estate by real estate agents. The database may operatively connect to a server, and be accessible through the Internet. Though, in some embodiments, a mail out may provide the information in the real estate database. The MLS may provide the database.

A next Step 206 comprises selecting the at least one property 100 from the real estate database. The property 100 comprises a residential dwelling. Though in other embodiments, the property 100 may include commercial property 100, land, and/or investment properties. A further Step 208 comprises extracting at least listing price 104a for the at least one property 100, a tax 104b for the at least one property 100, association fees for at least one property, if applicable.

In some embodiments, a Step 210 may include extracting an association fee 102 expense from the at least one property 100. The association fee 102 may include, without limitation, a home owner's association fee.

The method 200 may also include a Step 214 of calculating the monthly housing expense payment 106 for the property. The method 200 may utilize an algorithm in a mortgage calculator to calculate the monthly housing expense payment 106. The standard expenses may be adjusted, removed, or added to adjust the monthly housing expense payment 106 for different properties. A Step 216 comprises displaying the monthly housing expense payment 106 for the at least one property 100. The monthly housing expense payment 106 may display on the database, an MLS sheet, or on a table. In one embodiment, the calculations appear simultaneously for multiple properties on a single table, as shown in FIG. 1.

A further Step 218 of the method 200 may include negotiating the actual insurance cost expense, the insurance negotiation configured to enable convergence with the maximum repayment capacity 108 of the buyer for making the monthly housing expense payment 106. An additional Step of the method 200 comprises negotiating 220 the monthly housing expense payment 106, the loan negotiation configured to enable convergence with the repayment capacity 108 for the monthly housing expense payment 106. Both negotiation Steps 218, 220 use the final monthly housing expense payment 106 amount as leverage.

A final Step 222 comprises qualifying for the loan for the at least one property 100. This Step 222 may include proceeding to a pre-approval process. Various forms and deeper analysis of the buyer's financial history may be obtained at this point. However, since the method 200 has calculated the primary financial obstacles into the prequalification, the odds of obtaining the property 100 are high at this point.

In conclusion, the method 200 generates a more accurate projection of a buyer's capacity to qualify for a real estate loan for at least one property 100 by integrating all the elements of a monthly housing expense payment that a bank will take into account when qualifying a borrower, such as association fees, if applicable, property insurance cost, mortgage insurance, if applicable, and property tax. These expenses are not normally displayed in conjunction as a monthly payment when not in front of a loan originator 100. In this manner, the monthly housing expense payment 106 are accurately derived for accurate expectations, and leverage when negotiating the actual insurance cost and/or the monthly housing expense payment 106.

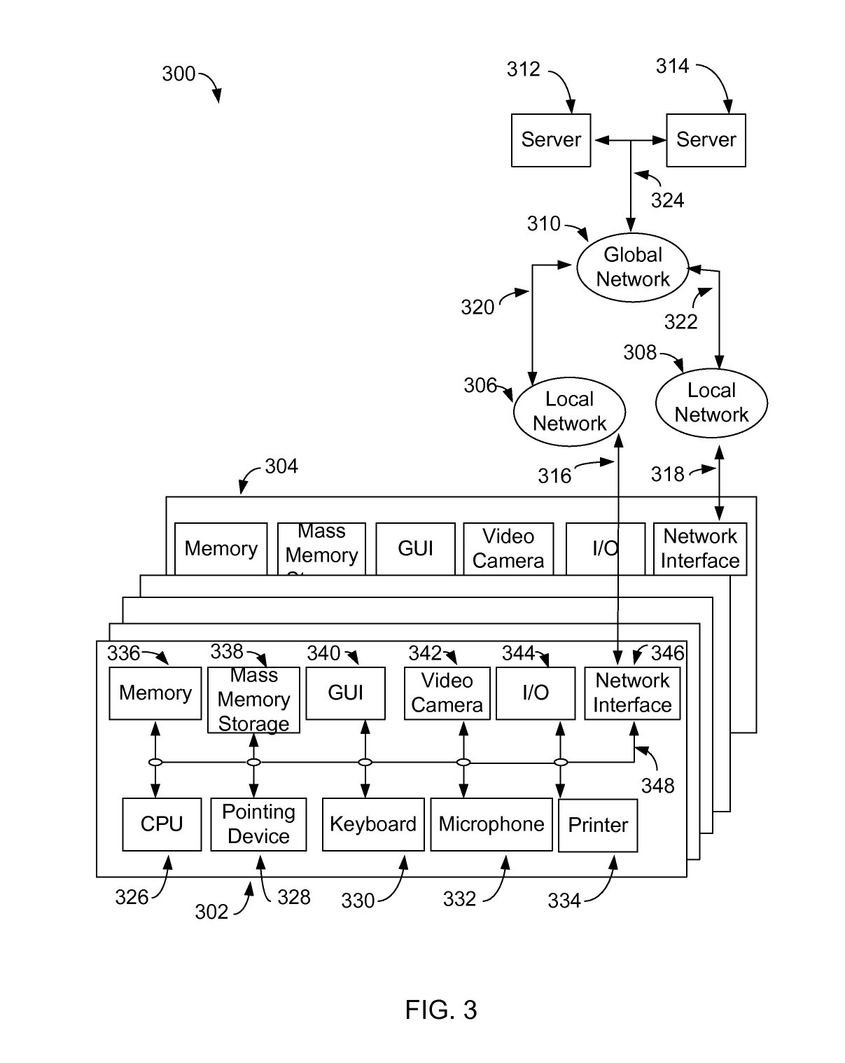

FIG. 3 is a block diagram depicting an exemplary client/server system which may be used by an exemplary web-enabled/networked embodiment of the present invention.

A communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. For example, the property may include a commercial property, a parcel of land, and an investment property. Accordingly, the scope should be determined not by the embodiments illustrated, but by the appended claims and their legal equivalents.

What is claimed is:

1. A method for automatically reading and calculating a monthly housing expense that a buyer will be able to pay if the buyer elects to purchase a certain property, the method comprises:
providing a system that will be used by a user;
providing a computer code that will be introduced into the system that will include an interest rate, a property insurance percentage and a mortgage insurance percentage that is imputed by a user;
providing a module that will import data from a real estate database, the real estate database imported will be a listing price, a property tax, and association fee, if applicable, and a property identifier; and
providing a module that calculates the interest rate, the property insurance percentage, the mortgage insurance percentage, if applicable, the listing price, the property taxes, the association fee, if applicable, to reach a monthly housing expense that the user will evaluate when deciding to purchase a property.

2. The method of claim 1, wherein the real estate database is integrated within the system.

3. The method of claim 2, wherein the system displays the monthly housing expense payment.

4. The method of claim 3, wherein the system displays the monthly housing expense payment as a dollar amount.

5. The method of claim 4, wherein the system displays the monthly housing expense on a spreadsheet or a website.

6. The method of claim 5, wherein the listing price and the interest rate include at least one member form the group consisting of: an FHA loan, a VA loan, and a conventional loan other than 20 percent down.

7. The method of claim 6, wherein the property is a residential dwelling.

8. The method of claim 7, wherein the association fee is a home owner's association fee.

9. The method of claim 8, wherein the user is a borrower, a real estate buyer, a real estate agent, a loan originator, or any person or entity interested in calculating or knowing a monthly housing expense payment.

10. The method of claim 9, wherein the real estate database is provided by a multiple listing service or a real estate website.

11. The method of claim 10, wherein the method is operable through the Internet.

12. A non-transitory program storage device readable by a machine tangibly embodying a program of instructions executable by the machine to perform a method for automatically reading and calculating a monthly housing expense that a buyer will be able to pay if the buyer elects to purchase a certain property, the storage device comprising:
computer code for providing a system that will be used by a user;
computer code for introducing into the system at least one form the following group: an interest rate, a property insurance percentage and a mortgage insurance percentage that is imputed by a user;
computer code for providing a module that will import data from a real estate database, the real estate database imported will be a listing price, a property tax, and association fee, if applicable, and a property identifier; and
computer code for providing a module that calculates the interest rate, the property insurance percentage, the mortgage insurance percentage, if applicable, the listing price, the property taxes, the association fee, if applicable, to reach a monthly housing expense that the user will evaluate when deciding to purchase a property.

13. The method of claim 12, wherein the real estate database is integrated within the system.

14. The method of claim 13, wherein the system displays the monthly housing expense payment.

15. The method of claim 14, wherein the system displays the monthly housing expense payment as a dollar amount.

16. The method of claim 15, wherein the system displays the monthly housing expense on a spreadsheet or a website.

17. The method of claim 16, wherein the listing price and the interest rate include at least one member form the group consisting of: an FHA loan, a VA loan, and a conventional loan other than 20 percent down.

18. The method of claim 17, wherein the property is a residential home.

19. The method of claim 18, wherein the association fee is a home owner's association fee.

20. The method of claim 19, wherein the user is a borrower, a real estate buyer, a real estate agent, a loan originator, or any person or entity interested in calculating a monthly housing expense payment.
